(19) United States
(12) Patent Application Publication
(10) Pub. No.: US 2003/0080557 A1
(43) Pub. Date: May 1, 2003

(54) Hose connector and method for sealingly connecting drain sections of an appliance

(76) Inventors: Jeffrey Joseph Benavides, Bayard, NM (US); John J. Roetker, Louisville, KY (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/012,795

(22) Filed: Oct. 30, 2001

(51) Int. Cl. F16L 33/00

(52) U.S. Cl. 285/239

(57) ABSTRACT

Hose connector and method for sealingly connecting respective first and second drain sections of an appliance are provided. The hose connector includes a mating piece positioned at a proximate end of one of the first and second drain sections. The mating piece is configured to define a bore. An insertion piece is configured at the corresponding proximate end of the other of the first and second drain sections to be received through the bore in the mating piece. One of the pieces is substantially rigid and includes at least a first radially-extending rib. The other of the pieces is generally resilient relative to the rigid piece. The radially-extending rib has a diameter sufficiently large relative to the corresponding diameter of the resilient piece to provide a hermetic seal to fluid passing through the connector, by substantially and uniformly compressing any portion of the resilient piece in contact with the rib in the rigid piece.

The present invention is generally related to appliances, and, more particularly, to hose connector and method for sealingly connecting an internal drain section of the appliance to an external drain section.

In many household appliances fluids must be drained from the interior of the appliance. In a washer, for example, respective hoses that extend through apertures formed in wall panels of the cabinet of the appliance are generally employed to supply clean water into the machine and, upon completion of predefined washing cycles, eventually drain the soiled laundry liquid. Often, hose connectors are employed so that, for example, an interior drain hose of the washer is attached to a connector at the factory, and an exterior drain hose can be attached to the connector from outside the cabinet for installation of the appliance in the field. It should be apparent that leaks that may develop at the joint interface between the external drain hose and the internal drain hose would be detrimental to both the operation of the appliance and to customer satisfaction. It should be also apparent that the connection of the external and internal hose sections needs to be performed within ergonomically acceptable installation parameters so that the installation of the external and internal hose sections does not become an unduly burdensome task to the installer.

Thus, in view of the foregoing considerations, it would be desirable to provide hose connector and techniques that, reliably and at a relatively low cost, allow to improve a seal provided to fluid passing through the connector while meeting the ergonomic parameters for effecting the connection between the external and the internal drain hose sections of the appliance.

### BRIEF SUMMARY OF THE INVENTION

Generally, the present invention fulfills the foregoing needs by providing in one aspect thereof, a hose connector for sealingly connecting respective first and second drain sections of an appliance. The hose connector includes a mating piece positioned at a proximate end of one of the first and second drain sections. The mating piece is configured to define a bore. An insertion piece is configured at the corresponding proximate end of the other of the first and second drain sections to be received through the bore in the mating piece. One of the pieces is substantially rigid and includes at least a first radially-extending rib. The other of the pieces is generally resilient relative to the rigid piece. The radially-extending rib has a diameter sufficiently large relative to the corresponding diameter of the resilient piece to provide a hermetic seal to fluid passing through the connector, by substantially and uniformly compressing any portion of the resilient piece in contact with the rib in the rigid piece.

The present invention further fulfills the foregoing needs by providing in another aspect thereof, a method for sealingly connecting respective first and second drain sections of an appliance. The method allows to provide a mating piece at a proximate end of one of the first and second drain sections. The mating piece is configured to define a bore. The method further allows to configure an insertion piece at the corresponding proximate end of the other of the first and second drain sections. One of the pieces is selected to be substantially rigid and includes at least a first radially-extending rib. The other of the pieces is selected to be generally resilient relative to the rigid piece. The radially-extending rib has a diameter sufficiently large relative to the corresponding diameter of the resilient piece to provide a hermetic seal therebetween. The insertion piece is received through the bore in the mating piece, and, as a result of the diametrical difference between the rib in the rigid piece and the bore in the resilient piece, any portion of the resilient piece in contact with the rib is compressed, thus providing a hermetic seal to fluid passing through the connector.

### BRIEF DESCRIPTION OF THE DRAWINGS

The features and advantages of the present invention will become apparent from the following detailed description of the invention when read with the accompanying drawings in which:

FIG. 1 illustrates an isometric exploded view of an exemplary embodiment of a hose connector in accordance with aspects of the present invention.

FIG. 2 illustrates a cross-sectional view of an elastomeric mating piece while receiving a relatively rigid insertion piece including a rib and shoulder configured to achieve and maintain a hermetic seal to fluid passing therethrough even in the presence of lateral loads.

FIG. 3 illustrates respective side views of exemplary domes that may be provided on the rib of FIG. 2.

FIG. 4 illustrates a side view of another exemplary embodiment for the insertion piece including multiple ribs, (e.g., two ribs) and a shoulder.

FIG. 5 illustrates a side view of still another exemplary embodiment for the insertion piece including multiple ribs, (e.g., two ribs) and no shoulder.

FIG. 6 illustrates a flow chart including exemplary steps or actions of a method for sealingly connecting respective first and second drain sections of an appliance in accordance with other aspects of the present invention.

### DETAILED DESCRIPTION OF THE INVENTION

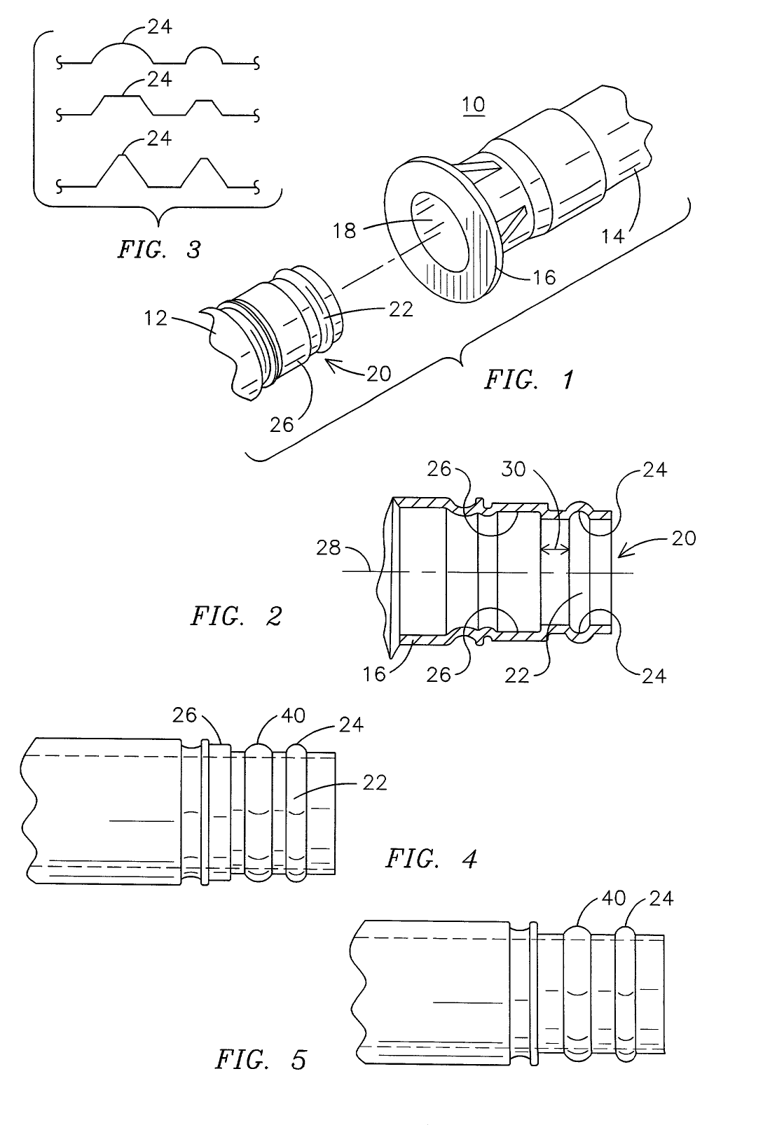

FIG. 1 illustrates an isometric exploded view of an exemplary embodiment of a hose connector 10 for sealingly connecting respective first and second drain sections 12 and 14 of an appliance, such as a washer. In one exemplary embodiment, the first drain section 12 may correspond to an external drain hose, and the second drain section 14 may correspond to an internal drain hose of the appliance. The hose connector includes a mating piece 16 positioned at a proximate end of one of the first and second drain sections, e.g., drain section 14. The mating piece 16 is configured to define a bore 18, which in one exemplary embodiment comprises a tapered bore. That is, the surface that defines the bore may be conically configured so that such a surface gradually slopes (e.g., at about one degree angle) relative to the entrance at the proximate end of the mating piece. An insertion piece 20 is configured at the corresponding proximate end of the other of the first and second drain sections (e.g., drain section 12) to be received through the bore in the mating piece 16. One of the pieces (e.g., insertion piece 20) is substantially rigid and includes at least a first radially-extending rib 22. In one exemplary embodiment, insertion piece 20 is made of polypropylene. It will be appreciated, however, that other polymer plastics or equivalent moldable or extrudable materials may be used. Polypropylene is just one example of a material that generally maintains its strength even after repeated flexing, has relatively low water absorption and moisture permeability and is resistant to attacks by fungi and/or bacteria. The other of the pieces (e.g., mating piece 16) is generally resilient relative to the rigid piece. In one exemplary embodiment, the mating piece is made of Santoprene elastomer. It will be appreciated, however, that other elastomers or equivalent materials, such as natural or synthetic rubber may be used. It will be further appreciated that the functional and operational interrelationships provided by the mating piece and the insertion piece could be reversed. For example, those skilled in the art will now recognize that instead of making the insertion piece of a relatively rigid material, such piece could be made of elastomer material configured with a radial rib and other associated structures as described in greater detail below, for providing a hermetic seal between the respective drain sections of the appliance joined by the hose connector. The mating piece in this case would be made of the relatively rigid material, and would include at its inner diameter a suitably configured bore, such as a tapered or conical bore. As best appreciated in FIG. 2, the radially-extending rib 22 has a diameter sufficiently large relative to the corresponding diameter of the resilient piece 16 to provide a hermetic seal to fluid passing through the connector, by substantially and uniformly compressing any portion of the resilient piece in contact with the rib in the rigid piece. The rib includes a dome 24 configured to provide a serpentine seal with the resilient piece. As better appreciated in FIG. 3, the dome geometry may take various configurations, such as spherical and pyramidal configurations including a pyramidal configuration truncated near its apex. Using design techniques well-understood by those skilled in the art, the overall diameter of the rib relative to the bore diameter, and the dimensions of the dome, e.g., dome radius of curvature, may be selected to achieve a desired level of squeeze for the seal. As suggested above, the squeeze level should be sufficiently high to achieve a hermetic seal. However, the squeeze level should be sufficiently low to meet the ergonomic requirements for any given application.

As shown in FIGS. 1-2, the insertion piece may include a radially-extending shoulder 26 axially spaced from the rib 22 in a direction opposite to the proximate end. In one exemplary embodiment, the shoulder is sufficiently wide along axis 28 (FIG. 2) to maintain relatively strong axial alignment between the mating and insertion pieces in the presence of lateral loads. That is, loads generally perpendicular to axis 28 that could otherwise detrimentally disturb the serpentine seal achieved by the compression of elastomeric material provided by rib 22. Further, the rib diameter is preferably selected to be larger relative to the shoulder diameter to facilitate entry of the insertion piece 20 into the mating piece 16. In one exemplary embodiment, the axial spacing (represented by a line 30 with twin-arrowheads in FIG. 2) between the rib 22 and the shoulder 26 is selected sufficiently apart to maintain the serpentine seal between the portion of the resilient piece in contact with the rib. Conversely, the axial spacing between the rib 22 and the shoulder 26 is selected sufficiently close to facilitate entry of the insertion piece into the mating piece. That is, if the shoulder is too close to the rib, then the quality of the serpentine seal achieved through the compression of the elastomeric material against the rib may be somewhat compromised. However, if the shoulder is too far apart from the rib, then an ergonomically-acceptable entry of the insertion piece into the mating piece may be tougher to achieve since one would lose the benefit resulting from the rib having a larger diameter relative to the shoulder. The shoulder in one exemplary embodiment may comprise a step-like shoulder. That is, a structure having a sharp rise followed by a flat surface substantially perpendicular to the sharp rise, and followed by a sharp drop off, also substantially perpendicular to the flat surface. However, it will be appreciated that the shoulder may be constructed to include a chamfer at its leading edge, or to include a tapered or conical surface, as opposed to a non-sloping surface, to facilitate entry of the insertion piece.

As illustrated in the respective embodiments of FIGS. 4 and 5, the insertion piece may further include a second radially-extending rib 40 spaced from the first rib 22 opposite to the proximate end. As suggested above, the diameter of the second rib 40 is preferably larger than the diameter of the first rib 22 to facilitate entry of the insertion piece into the mating piece. In embodiments including multiple ribs, the respective domes and diameters of such multiple ribs may be configured to provide a different level of squeeze to the respective seals respectively provided by such multiple ribs. As will be readily understood by those skilled in the art, in applications where typical side loads are relatively low, then the insertion piece need not include any shoulder. In this case, the insertion piece could just include a single or multiple ribs, as illustrated in FIG. 5, without any shoulder, to achieve the hermetic seal between the respective drain sections of the appliance. FIG. 4 illustrates an embodiment that includes multiple ribs (e.g., first and second ribs 24 and 40) and a shoulder 26 having a relatively narrower axial width, as compared to the shoulder used with a single rib, as exemplified by the embodiment of FIG. 2. In this case, it is believed that the second rib 40 in combination with the relatively narrower shoulder 26 may be sufficient to provide acceptable axial alignment for many applications where the expected level of side loads to be encountered by the connector is relatively moderate.

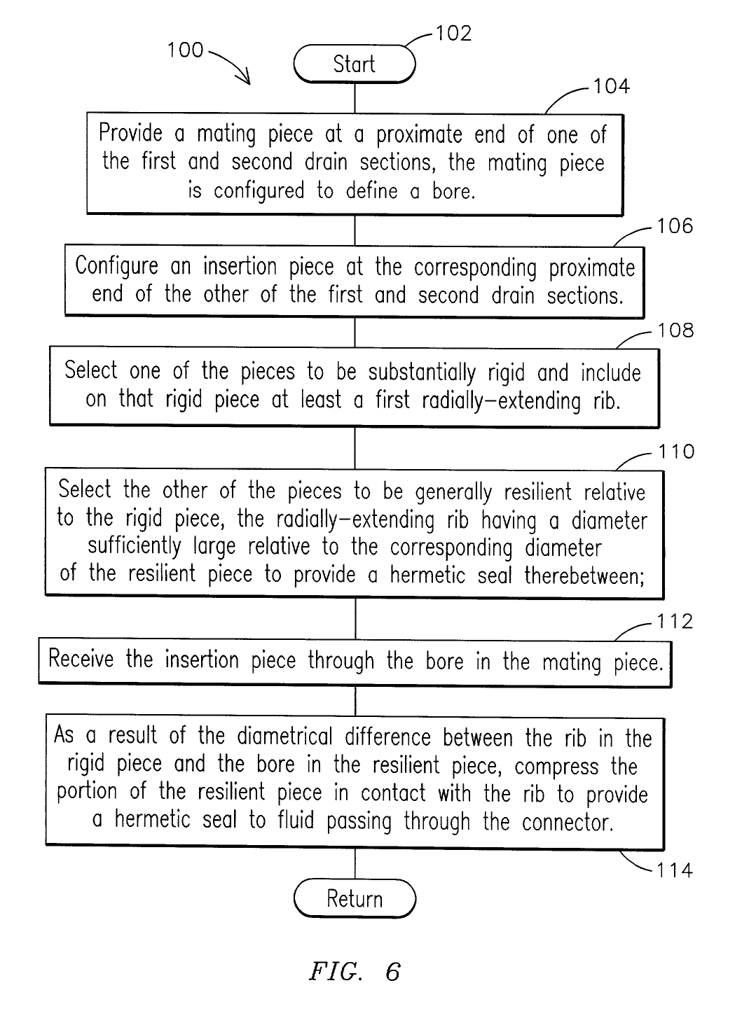

FIG. 6 illustrates a flow chart 100 including exemplary steps or actions in connection with a method for sealingly connecting respective first and second drain sections of an appliance. Subsequent to start step 102, step 104 allows to provide a mating piece 16 (FIG. 1) at a proximate end of one of the first and second drain sections (e.g., drain section 14 (FIG. 1)). The mating piece is configured to define a bore 18. Step 106 allows to configure an insertion piece 20 at the corresponding proximate end of the other of the first and second drain sections (e.g., drain section 12 FIG. 1). One of the pieces (e.g., insertion piece 20) is selected to be substantially rigid and includes at least a first radially-extending rib 22. The other of the pieces (e.g., mating piece 16) is selected to be generally resilient relative to the rigid piece. The radially-extending rib has a diameter sufficiently large relative to the corresponding diameter of the resilient piece to provide a hermetic seal therebetween. The insertion piece is received through the bore in the mating piece, and, as a result of the diametrical difference between the rib in the rigid piece and the bore in the resilient piece, any portion of the resilient piece in contact with the rib is compressed, thus providing a hermetic seal to fluid passing through the connector. As suggested above, the present invention offers various cost-effective techniques for optimizing the quality of the seal even in the presence of side loads and for meeting ergonomic requirements for installation of the drain hoses of the appliance.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A hose connector for sealingly connecting respective first and second drain sections of an appliance, the hose connector comprising:
a mating piece positioned at a proximate end of one of the first and second drain sections, the mating piece configured to define a bore; and
an insertion piece configured at the corresponding proximate end of the other of the first and second drain sections to be received through the bore in the mating piece, one of the pieces being substantially rigid and including at least a first radially-extending rib, the other of the pieces being generally resilient relative to the rigid piece, the radially-extending rib having a diameter sufficiently large relative to the corresponding diameter of the resilient piece to provide a hermetic seal to fluid passing through the connector, by substantially and uniformly compressing any portion of the resilient piece in contact with the rib in the rigid piece.

2. The hose connector of claim 1 wherein the rib includes a dome configured to provide a serpentine seal with the resilient piece.

3. The hose connector of claim 2 wherein the dome configuration is selected from the group consisting of spherical and pyramidal configurations.

4. The hose connector of claim 1 wherein the rigid piece further comprises a radially-extending shoulder axially spaced from the rib opposite to the proximate end, the shoulder being sufficiently wide to maintain axial alignment between the mating and insertion pieces in the presence of lateral loads.

5. The hose connector of claim 4 wherein the diameter of the first rib is larger than the diameter of the shoulder to facilitate entry of the insertion piece into the mating piece.

6. The hose connector of claim 4 wherein the axial spacing between the first rib and the shoulder is sufficiently apart to maintain a serpentine seal between the portion of the resilient piece in contact with the rib, and sufficiently close to facilitate entry of the insertion piece into the mating piece.

7. The hose connector of claim 1 wherein the rigid piece further comprises a second radially-extending rib spaced from the first rib opposite to the proximate end, the diameter of the first rib being smaller than the diameter of the second rib.

8. The hose connector of claim 7 wherein the second rib includes a respective dome configured to provide an additional serpentine seal with any portion of the resilient piece in contact with the second rib.

9. The hose connector of claim 8 wherein the respective domes on the first and second ribs are configured to provide a different level of squeeze to the respective seals respectively provided therewith.

10. The hose connector of claim 7 wherein the rigid piece further comprises a radially-extending shoulder axially spaced from the second rib opposite to the proximate end, the shoulder being sufficiently wide to maintain axial alignment between the mating and insertion pieces in the presence of lateral loads.

11. The hose connector of claim 10 wherein the diameter of the second rib is larger than the diameter of the shoulder to facilitate full entry of the insertion piece into the mating piece.

12. A method for sealingly connecting respective first and second drain sections of an appliance, the method comprising:
providing a mating piece at a proximate end of one of the first and second drain sections, the mating piece configured to define a bore;
configuring an insertion piece at the corresponding proximate end of the other of the first and second drain sections;
selecting one of the pieces to be substantially rigid and including on that rigid piece at least a first radially-extending rib;
selecting the other of the pieces to be generally resilient relative to the rigid piece, the radially-extending rib having a diameter sufficiently large relative to the corresponding diameter of the resilient piece to provide a hermetic seal therebetween;
receiving the insertion piece through the bore in the mating piece; and
as a result of the diametrical size difference between the rib in the rigid piece and the bore in the resilient piece, compressing any portion of the resilient piece in contact with the rib, thus providing a hermetic seal to fluid passing through the connector.

13. The connecting method of claim 12 further comprising configuring a dome on the rib to provide a serpentine seal with the resilient piece.

14. The connecting method of claim 13 wherein the dome configuration is selected from the group consisting of spherical and pyramidal configurations.

15. The connecting method of claim 12 further comprising providing a radially-extending shoulder on the rigid piece, the shoulder being axially spaced from the rib opposite to the proximate end, and being sufficiently wide to maintain axial alignment between the mating and insertion pieces in the presence of lateral loads.

16. The connecting method of claim 15 further comprising dimensioning the diameter of the first rib to be larger than the diameter of the shoulder to facilitate entry of the insertion piece into the mating piece.

17. The connecting method of claim 15 further comprising selecting the axial spacing between the first rib and the shoulder to be sufficiently apart to maintain a serpentine seal between the portion of the resilient piece in contact with the rib, and sufficiently close to facilitate entry of the insertion piece into the mating piece.

18. The connecting method of claim 12 further comprising providing a second radially-extending rib spaced from the first rib opposite to the proximate end, the diameter of the first rib being smaller than the diameter of the second rib.

19. The connecting method of claim 18 further comprising configuring a dome on the second rib to provide an additional serpentine seal with any portion of the resilient piece in contact with the second rib.

20. The connecting method of claim 19 wherein the respective domes on the first and second ribs are further configured to provide a different level of squeeze to the respective seals respectively provided therewith.

21. The connecting method of claim 18 further comprising providing a radially-extending shoulder axially spaced from the second rib opposite to the proximate end, the shoulder being sufficiently wide to maintain axial alignment between the mating and insertion pieces in the presence of lateral loads.

22. The connecting method of claim 21 wherein the diameter of the second rib is larger than the diameter of the shoulder to facilitate full entry of the insertion piece into the mating piece.

23 A method for sealingly connecting respective first and second drain sections of an appliance, the method comprising:
providing a mating piece at a proximate end of one of the first and second drain sections, the mating piece configured to define a bore;
configuring an insertion piece at the corresponding proximate end of the other of the first and second drain sections;
selecting one of the pieces to be substantially rigid;
selecting the other of the pieces to be generally resilient relative to the rigid piece, with that resilient piece including at least a first radially-extending rib having a diameter sufficiently large relative to the corresponding diameter of the rigid piece to provide a hermetic seal therebetween;
receiving the insertion piece through the bore in the mating piece; and
as a result of the diametrical size difference between the rib in the resilient piece and the bore of the rigid piece, compressing any portion of the resilient piece in contact with the bore, thus providing a hermetic seal to fluid passing through the connector.

24. The connecting method of claim 23 further comprising configuring a dome on the rib to provide a serpentine seal with the rigid piece.

25. The connecting method of claim 23 wherein the dome configuration is selected from the group consisting of spherical and pyramidal configurations.

26. The connecting method of claim 24 further comprising providing a radially-extending shoulder on the resilient piece, the shoulder being axially spaced from the rib opposite to the proximate end, and being sufficiently wide to maintain axial alignment between the mating and insertion pieces in the presence of lateral loads.

27. The connecting method of claim 26 further comprising dimensioning the diameter of the first rib to be smaller than the diameter of the shoulder to facilitate entry of the resilient insertion piece into the mating piece.

28. The connecting method of claim 26 further comprising selecting the axial spacing between the first rib and the shoulder to be sufficiently apart to maintain a serpentine seal between the portions of the resilient insertion piece as they contact the bore of the mating piece.

29. The connecting method of claim 23 further comprising providing a second radially-extending rib spaced from the first rib opposite to the proximate end, the diameter of the first rib being smaller than the diameter of the second rib to facilitate entry of the insertion piece into the mating piece.

30. The connecting method of claim 29 further comprising configuring a dome on the second rib to provide an additional serpentine seal when in contact with the mating piece.

31. The connecting method of claim 30 wherein the respective domes on the first and second ribs are further configured to provide a different level of squeeze to the respective seals respectively provided therewith.

32. The connecting method of claim 29 further comprising providing a radially-extending shoulder axially spaced from the second rib opposite to the proximate end, the shoulder being sufficiently wide to maintain axial alignment between the mating and insertion pieces in the presence of lateral loads.

33. The connecting method of claim 32 wherein the diameter of the second rib is larger than the diameter of the shoulder to facilitate full entry of the insertion piece into the mating piece.
